(19) United States
(12) Patent Application Publication
(10) Pub. No.: US 2016/0121245 A1
(43) Pub. Date: May 5, 2016

(54) FILTER ELEMENT AND METHOD FOR MANUFACTURING THE FILTER ELEMENT

(71) Applicant: OUTOTEC (FINLAND) OY, Espoo (FI)

(72) Inventors: Bjarne EKBERG, Turku (FI); Jason PALMER, Clayfield, Queensland (AU)

(73) Assignee: OUTOTEC (FINLAND) OY, Espoo (FI)

(21) Appl. No.: 14/894,230

(22) PCT Filed: May 30, 2014
(86) PCT No.: PCT/FI2014/050438

§ 371 Date: Nov. 25, 2015

(30) Foreign Application Priority Data
May 31, 2013 (FI) 20135607

(51) Int. Cl. B01D 35/06; B01D 39/20

(52) U.S. Cl. CPC B01D 35/06; B01D 39/2072

(57) ABSTRACT

Magnetic elements are provided inside a ceramic filter plate for creating a magnetic field. In an embodiment of the invention, magnetic elements are located in cavities provided in partition walls which define filtrate channels between themselves. The filter plate can be used for increasing filtration capacity particularly in magnetite applications. The magnetic field causes an attractive force on the magnetic particles and thus increases the amount of material forming on the filter plate in a vacuum filter, such as a capillary action filter, conventional rotary vacuum filter or drum filter or capillary action drum filter.

### FIELD OF THE INVENTION

The present invention relates generally to ceramic filter elements.

### BACKGROUND OF THE INVENTION

Filtration is a widely used process whereby a slurry or solid liquid mixture is forced through a media, with the solids retained on the media and the liquid phase passing through. This process is generally well understood in the industry. Examples of filtration types include depth filtration, pressure and vacuum filtration, and magnetic, gravity and centrifugal filtration.

Both pressure and vacuum filters are used in the dewatering of mineral concentrates. The principal difference between pressure and vacuum filters is the way the driving force for filtration is generated. In pressure filtration, overpressure within the filtration chamber is generated with the help of e.g. a diaphragm, a piston, or external devices, e.g. a feed pump. Consequently, solids are deposited onto the filter medium and filtrate flows through into the filtrate channels. Pressure filters often operate in batch mode because continuous cake discharge is more difficult to achieve.

The cake formation in vacuum filtration is based on generating suction within the filtrate channels. Several types of vacuum filters exist, ranging from belt filters to rotary vacuum drum filters and rotary vacuum disc filters.

Rotary vacuum disc filters are used for the filtration of suspensions on a large scale, such as the dewatering of mineral concentrates. The dewatering of mineral concentrates requires large capacity in addition to producing a cake with low moisture content. Such large processes are commonly energy intensive and means to lower the specific energy consumption are needed. The vacuum disc filter may comprise a plurality of filter discs arranged in line co-axially around a central pipe or shaft. Each filter disc may be formed of a number of individual filter sectors, called filter plates, that are mounted circumferentially in a radial plane around the central pipe or shaft to form the filter disc, and as the shaft is fitted so as to revolve, each filter plate or sector is, in its turn, displaced into a slurry basin and further, as the shaft of rotation revolves, rises out of the basin. When the filter medium is submerged in the slurry basin where, under the influence of the vacuum, the cake forms onto the medium. Once the filter sector or plate comes out of the basin, the pores are emptied as the cake is deliquored for a predetermined time which is essentially limited by the rotation speed of the disc. The cake can be discharged by a back-pulse of air or by scraping, after which the cycle begins again.

In a rotary vacuum drum filter, filter elements, e.g. filter plates, are arranged to form an essentially continuous cylindrical shell or envelope surface, i.e a filter drum. The drum rotates through a slurry basin and the vacuum sucks liquid and solids onto the drum surface, the liquid portion is “sucked” by the vacuum through the filter media to the internal portion of the drum, and the filtrate is pumped away. The solids adhere to the outside of the drum and form a cake. As the drum rotates, the filter elements with the filter cakes rise out of the basin, the cakes are dried and removed from the surface of the drum.

The most commonly used filter media for vacuum filters are polymeric filter cloths and ceramic filter media. Whereas the use of a cloth filter medium requires heavy duty vacuum pumps, due to vacuum losses through the cloth during cake deliquoring, the ceramic filter medium, when wetted, does not allow air to pass through which does not allow air to pass through, which further decreases the necessary vacuum level, enables the use of smaller vacuum pumps and, consequently, yields significant energy savings.

The magnetic separation technology was initially aimed the processing of strongly magnetic ores but today magnetic separation is applied in the treatment of waste waters, in biotechnologies, pharmaceutical applications etc. Stolarski et al., Magnetic field enhanced press-filtration, Chemical Engineering Science 61 (2006), p. 6395-6403, discloses an experimental magnetically enhanced press filtration using a press filter cell which consists of a filtration chamber built by a cake building ring and two filter plates. The used filter media was placed between the cake building ring and the filter plate, and a magnetic field was attached to one side of the press filtration cell. Hence, the filtration cell consists of a magnet side and a non-magnet side. The applied feed slurry was a suspension of ferromagnetic iron oxide. According to Stolarski et al. the presence of a magnetic field results in an increase of filtrate flow especially at the beginning of the filtration process, and it has a positive effect on the filtration kinetics (permeability and cake resistance). As a negative side effect of the filtration with superposed permanent magnetic field is that the capacity of the filter chamber is much lower due to the structuring of the filter cake. Similar experimental press filtration cell is disclosed in Eichholz et al., Magnetic field enhanced cake filtration of superparamagnetic PVAc-particles, Chemical Engineering Science 63 (2008), p. 3193-3200.

U.S. Pat. No. 8,075,771 and U.S. Pat. No. 8,066,877 discloses magnetic field gradient enhanced cake filters. The magnetic pressure cake filter includes a container containing a solid-liquid mixture and a filter media. A pressure is applied to to the solid-liquid mixture so that the pressure at the top of the mixture exceeds that of the filter media. The container is placed within a solenoidal magnet so that the solid-liquid mixture in the container is subjected to a magnetic field provided by the magnet. U.S. Pat. No. 8,066,877 mentions also that in addition to a conventional cake-filtration configuration, the apparatus for solid-liquid separation may take the form of a drum filter, as disc filter, a candle filter, a cross-flow filter or any other type of apparatus that relies on cake-filteration for separation. However, U.S. Pat. No. 8,066,877 discloses construction examples only for a cross-flow filter and a candle filter. The cross-flow filter disclosed is in form of a tube of a filter membrane and single magnetic wire in proximity to, or along, the axis of the tube. The tube and the magnetic wire are subjected to a magnetic field. The solid-liquid mixture is fed into one end of the tube. the magnetic particles in the mixture are attracted to and adhere to the magnetic wire as a result of the gradient magnetic forces in the vicinity of the wire in the magnetic field. The liquid passes through the filter membrane of the tube along the length of the tube and is collected as a filtrate. Periodically the magnetic wire is removed from the tube and the magnetic particles are cleaned from the wire. A plurality of similar tubes with one open end may be arranged to form a candle filter.

### BRIEF DESCRIPTION OF THE INVENTION

An aspect of the present invention is to increase filtration capacity of ceramic filter elements used in removal of liquid from solids containing material to be dried in a capillary suction dryer. Aspects of the invention are a filter plate, an apparatus and method according to the independent claims. Embodiments of the invention are disclosed in the dependent claims.

An aspect of the invention is a filter element to be used in removal of liquid from solids containing material in a capillary suction dryer, the filter element comprising:

a ceramic substrate having a first surface and a second opposite surface,

a ceramic microporous layer covering at least one of the first and the second surfaces of the ceramic substrate,

filtrate channels provided within the ceramic porous substrate, whereby a negative pressure can be maintained within the filtrate channels directing liquid from the outer surface of the ceramic microporous layer by capillary action through the microporous layer and further through the ceramic substrate into the filtrate channels and further out of the filter element.

The filter element is characterized in that it comprises further magnetic material within the ceramic substrate or on an opposite surface of the ceramic substrate in relation to the microporous layer in the case the microporous layer is positioned on only one of the first and second surfaces of the ceramic substrate.

In an embodiment, the magnetic material is provided in or between the filtrate channels.

In an embodiment, in combination with any preceding embodiment, the magnetic material is provided in the ceramic substrate zones which define the filtrated channels between themselves.

In an embodiment, in combination with any preceding embodiment, the magnetic material comprises magnetic elements located in cavities provided in the ceramic substrate zones which define the filtrated channels between themselves.

In an embodiment, in combination with any preceding embodiment, the ceramic substrate comprises two half-plates glued together, and wherein the magnetic material comprises magnetic particles mixed into glue gluing the half-plates together.

In an embodiment, in combination with any preceding embodiment, a core of the ceramic substrate and thereby the filtrate channels is formed by a granular core material, and wherein the granular core material contains magnetic particles or elements.

In an embodiment, in combination with any preceding embodiment, the magnetic material comprises magnetic sheet material provided in the ceramic substrate to form zones which define the filtrate channels between themselves.

In an embodiment, in combination with any preceding embodiment, the ceramic substrate comprises two half-plates fixed together, and wherein the magnetic material comprises a magnetic sheet provided between the half-plates, the magnetic sheet comprising an opening pattern that matches to the filtrate channels within the ceramic substrate.

In an embodiment, in combination with any preceding embodiment, the ceramic substrate comprises two half-plates fixed together, each of the half-plates having filtrate channels on the opposing surfaces, and wherein the magnetic material comprises a magnetic sheet provided between the half-plates.

In an embodiment, in combination with any preceding embodiment, the ceramic microporous layer covers only one of the first and the second surfaces of the ceramic substrate, and the magnetic material is provided on the other of the first and the second surfaces of the ceramic substrate.

In an embodiment, in combination with any preceding embodiment, the ceramic microporous layer covers only one of the first and the second surfaces of the ceramic substrate, and the magnetic material is within the ceramic substrate close to the other of the first and the second surfaces of the ceramic substrate between the filtrate channels and the said other of the first and the second surfaces of the ceramic substrate.

In an embodiment, in combination with any preceding embodiment, the ceramic filter element is made of magnetic material.

In an embodiment, in combination with any preceding embodiment, the magnetic material comprises permanent magnets or electromagnets.

A further aspect of the invention is a filter apparatus comprising one or more filter elements according to any combination of preceding embodiments.

A still further aspect of the invention is a method for manufacturing a filter element to be used in removal of liquid from solids solids containing material in a capillary suction dryer, wherein the method comprises the steps of:

providing a ceramic substrate with filtrate channels within the ceramic substrate, said ceramic substrate having a first surface and a second opposite surface,

coating at least one of the first and the second surface of the ceramic substrate with a ceramic microporous material layer,

whereby a negative pressure can be maintained within the filtrate channels directing liquid from the outer surface of the ceramic microporous layer by capillary action through the microporous layer and further through the ceramic substrate into the filtrate channels and further out of the filter element.

The method is characterized by the step of:

providing magnetic material within the ceramic substrate.

In an embodiment, the method comprises making the filter element or the ceramic substrate of a magnetic material.

### BRIEF DESCRIPTION OF THE DRAWINGS

In the following the invention will be described in greater detail by means of example embodiments with reference to the accompanying drawings, in which

FIG. 1 is a perspective top view illustrating an exemplary disc filter apparatus, wherein embodiments of the invention may be applied;

FIG. 2 is a perspective top view of an exemplary sector-shaped ceramic filter plate;

FIGS. 3A, 3B and 3C illustrate exemplary structures of a ceramic filter plate wherein embodiments of the invention may be applied;

FIGS. 4A, 4B and 4C illustrate different phases of a filtering process;

FIG. 5A illustrates cross-sectional top view a ceramic substrate (e.g. a bottom half-plate) provided with magnetic material 51 according to exemplary embodiment of the invention;

FIG. 5B is an enlarged illustrates cross-sectional top view of a portion of the ceramic substrate shown in FIG. 5A;

FIG. 5C is an enlarged cross-sectional side view taken along line A-A from the ceramic substrate shown in FIG. 5B;

FIG. 5D is a cross-sectional side view of the ceramic substrate having magnetic elements in a granule core material;

FIG. 5E is a cross-sectional side view of the ceramic substrate having magnetic particles in a granule core material;

FIG. 6A illustrates cross-sectional top view a ceramic substrate (e.g. a bottom half-plate) provided with a patterned magnetic sheet 50 according to exemplary embodiment of the invention;

FIG. 6B is an enlarged illustrates cross-sectional top view of a portion of the ceramic substrate shown in FIG. 6A;

FIG. 6C is an enlarged cross-sectional side view taken along line A-A from the ceramic substrate shown in FIG. 6B;

FIG. 6D is a cross-sectional side view of the ceramic substrate having an alternative magnetic sheet structure;

FIG. 6E is a cross-sectional side view of the ceramic substrate having another alternative magnetic sheet structure;

FIG. 6F is a cross-sectional side view of the ceramic substrate having still another alternative magnetic sheet structure;

FIGS. 7A and 7B are a perspective top view and cross-sectional side view, respectively, of a ceramic substrate having a glue containing magnetic particles;

FIG. 8A is a cross-sectional side view of a filter plate with microporous membrane only on one surface and magnetic material inside the substrate; and

FIG. 8B is a cross-sectional side view of a filter plate with microporous membrane only on one surface and magnetic material on the back side of the substrate.

### DESCRIPTION OF EXEMPLARY EMBODIMENTS

Principles of the invention can be applied for drying or de-watering fluid materials in any industrial processes, particularly in mineral and mining industries. In embodiments described herein, a material to be filtered is referred to as slurry, but embodiments of the invention are not intended to be restricted to this type of fluid material. The slurry may have high solids concentration, e.g. base metal concentrates, iron ore, chromite, ferrochrome, copper, gold, cobalt, nickel, zinc, lead and pyrite. In the following, example embodiments of filter plates for rotary vacuum disc filters are illustrated but the principles of the invention can be applied also for filter media of other types of vacuum filters, such as rotary vacuum drum filters.

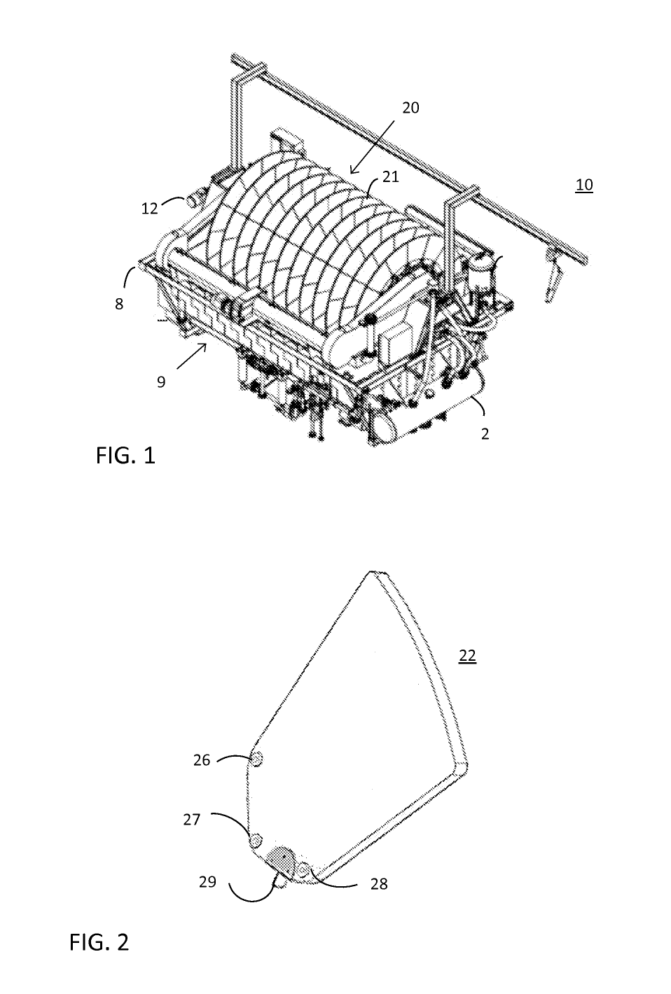

FIG. 1 is a perspective top view illustrating an exemplary disc filter apparatus in which filter plates according to embodiments of the invention may be applied. The exemplary disc filter apparatus 10 comprises a cylindrical-shaped drum 20 that is supported by bearings on a frame 8 and rotatable about the longitudinal axis of the drum 20 such that the lower portion of the drum is submerged in a slurry basin 9 located below the drum 20. A drum drive 12 (such as an electric motor, a gear box) is provided for rotating the drum 20. The drum 20 comprises a plurality of ceramic filter discs 21 arranged in line co-axially around the central axis of the drum 20. For example, the number of the ceramic filter discs may range from 2 to 20. The diameter of each disc 21 may be large, ranging from 1.5 to 4 m, for example. Examples of commercially available disc filters in which embodiments of the invention may be applied, include Outotec Larox CC filters, models CC-6, CC-15, CC-30, CC-45, CC-60, CC-96 and CC-144 manufactured by Outotec Oyj.

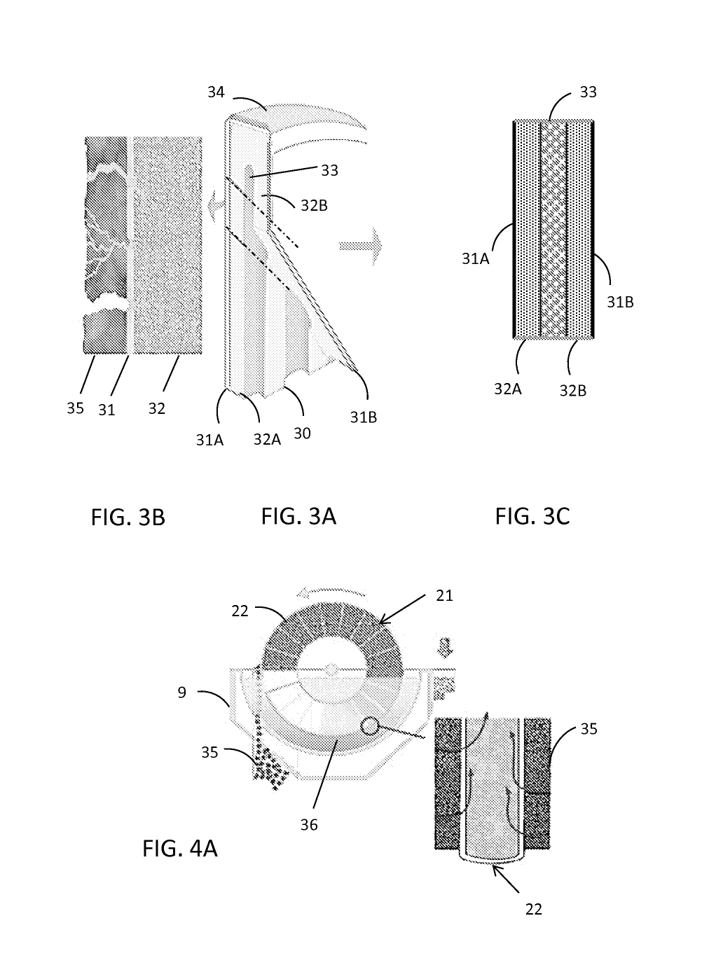

Each filter disc 21 may be formed of a number of individual sector-shaped ceramic filter elements, called filter plates, mounted in a radial planar array around the central axis of the drum to form an essentially continuous and planar disc surface. The number of the filter plates may be 12 or 15, for example. FIG. 2 is a perspective top view of an exemplary sector-shaped ceramic filter plate. The filter plate 22 may be provided with mounting parts, such as fastening hubs 26, 27 and 28 which function as means for attaching the plate 22 to mounting means in the drum. FIGS. 3A, 3B and 3C illustrate exemplary structures of a ceramic filter plate wherein embodiments of the invention may be applied. A microporous filter plate 22 may comprise a first suction structure 31A, 32A and an opposed second suction structure 31B, 32B. The first suction structure comprises a microporous membrane 31A and a ceramic substrate 32A, whereon the membrane 31A is positioned. Similarly, the second suction wall comprises a microporous membrane 31B and a ceramic substrate 32B. An interior space 33 is defined between the opposed first and second suction structure 31A, 32A and 31B, 32B resulting in a sandwich structure. The filter plate 22 may also be provided with connecting part 29, such as a filtrate tube or a filtrate nozzle, for drainage of fluids. The interior space 33 provides a flow channel or channels which will have a flow connection with collecting piping in the drum 20, e.g. by means of a tube connector 29. When the collecting pipe is connected to a vacuum pump, the interior 33 of the filter plate 22 is maintained at a negative pressure, i.e. a pressure difference is maintained over the suction wall. The membrane 31 contains micropores that create strong capillary action in contact with water. The pore size of the microporous membrane 31 is preferably in the range of 0.2 to 5 micrometer and that will make possible that only liquid is flowed through the microporous layer. The interior space 33 may be an open space or it may be filled with a granular core material which acts as a reinforcement for the structure of the plate. Due to its large pore size and high volume fraction of porosity, the material does not prevent the flow of liquid that enters into the central interior space 33. The interior space 33 may further comprise supporting elements or partition walls 30 to further reinforce the structure of the plate 22. The edges 34 of the plate may be sealed by means of painting or glazing or another suitable means to seal, thus preventing flow through the edges.

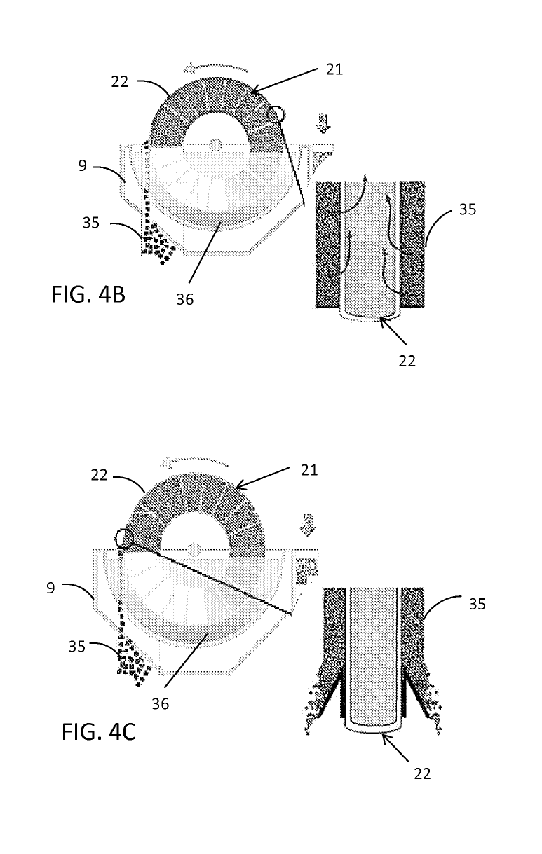

In exemplary embodiments the filter plates 22 of the consecutive discs are disposed in rows, each row establishing a sector or zone of the disc 21. As the row of the filter discs 21 rotate, the plates 22 of the each disc 22 move into and through the basin 9. Thus, each filter plate 22 goes through four different process phases or sectors during one rotation of the disc 21. In a cake forming phase, a partial vacuum is transmitted to the filter plates 22 and filtrate is drawn through the ceramic plate 22 as it is immersed into the slurry basin 9, and a cake 35 forms on the surface of the plate 22. The liquid or filtrate in the central interior space 33 is then transferred into the collecting pipe and further out of the drum 20. The plate 22 enters the cake drying phase (illustrated in FIG. 4B) after it leaves the basin 9. A partial vacuum is maintained in the filter plates 22 also during the drying phase so as to draw more filtrate from the cake 35 and to keep the cake 35 on the surface of the filter plate 35. If cake washing is required, it is done in the beginning of the drying phase. In the cake discharge phase illustrated in FIG. 4C, the cake 35 is scraped off by scrapers so that a thin cake is left on the plate 22 (gap between the scraper and the plate 22). After the cake discharge, in a cleaning phase (commonly called a backwash or backflush phase) of sector of each rotation, water or filtrate is pumped with overpressure in a reverse direction through the plate 22 to wash off the residual cake and clean the pores of the filter plate.

An aspect of the invention is enhancing filtration capacity in ceramic filters in ceramic filters utilizing magnetism. Embodiments of the invention are especially suitable for enhancing filtration of magnetite slurry.

According to an aspect of the invention a filter plate of any material having at least one magnetic element inside for creating a magnetic field, is provided. The filter plate can be used for increasing filtration capacity particularly in magnetite applications. The magnetic field causes an attractive force on the magnetic particles and thus increases the amount of material forming on the filter plate in a vacuum filter, such as a capillary action filter, conventional rotary vacuum filter or drum filter or capillary action drum filter. The magnetic field also has an impact on the orientation of particles in the cake increasing filtration capacity.

In embodiments of the invention the filter element comprises a ceramic substrate, a ceramic microporous layer covering the ceramic substrate, filtrate channels within the ceramic substrate, and magnetic material provided in and/or between or behind the filtrate channels within the ceramic substrate.

In some embodiments, the magnetic material is provided in the ceramic substrate zones which define the filtrated channels between themselves.

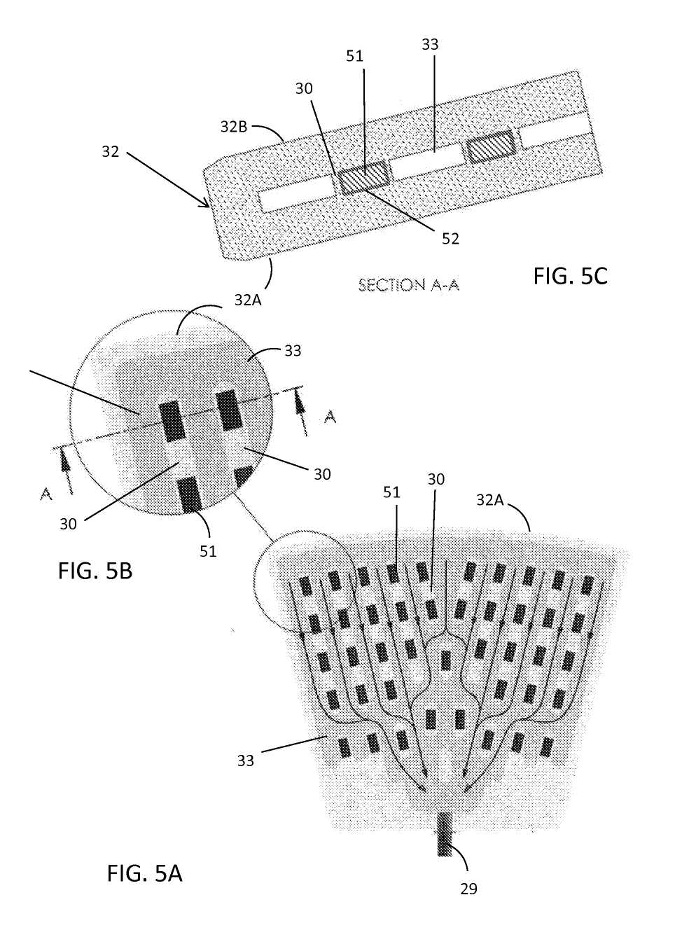

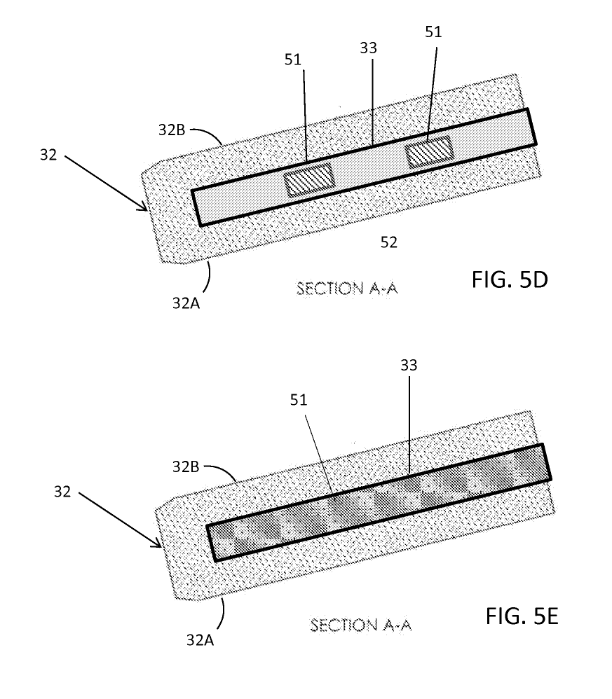

In some embodiments, the magnetic material comprises magnetic elements located in cavities provided in the ceramic substrate zones which define the filtrated channels between themselves. An exemplary embodiment is illustrated in FIGS. 5A, 5B and 5C. FIG. 5A illustrates cross-sectional top view of a ceramic substrate 32. In the case of embodiments where the final ceramic substrate 32 is formed of two half-plates 32A and 32B attached together, FIG. 5A may illustrated one of the half-plates 32A, while the other half-plate 32B may be a mirror-image. The substrate 32 may be similar to that illustrated in FIG. 3A that comprises filtrate channels 33 within the ceramic substrate. The ceramic substrate 32 may have ceramic substrate zones, such as partition walls 30 which define the filtrate channels 33 between themselves. The substrate zones or partition walls 30 may be provided with cavities 52 for accommodating magnetic material, such as magnetic elements 51. In the example shown, the magnetic elements 51 comprise substantially rectangular-shaped pieces of magnetic material with a thickness (height) that substantially matches to that of the filtrate channels 33. The cavities 52 or at least part of them may alternatively comprise part of the filtrate channels 33, i.e. the magnetic material or elements 33 may occupy part of the filtrate channels 33.

In embodiments, the interior space of the ceramic substrate 32, and thereby the filtrate channel 33 may be formed by a granular core material, and the magnetic material or elements 51 may installed in the core material such that the filtrate can flow between the magnetic elements 51, as illustrated in in FIG. 5D. The resulting configuration may be similar to the example shown in FIGS. 5A, 5B and 5C except that no specific channel-defining substrate zones or partition walls 30 can be recognized.

In an embodiment, magnetic material may comprise magnetic particles 51 mixed into the granular core material which provide the filtrate channels 33 within the ceramic substrate 32, as illustrated in FIG. 5E. As described above, due to its large pore size and high volume fraction of porosity, the granular core material does not prevent the flow of liquid. A small portion of magnetic particles in the core material still allows a sufficient flow of filtrate. The pattern of magnetized zones within a ceramic substrate 32 will correspond to the filtrate channels.

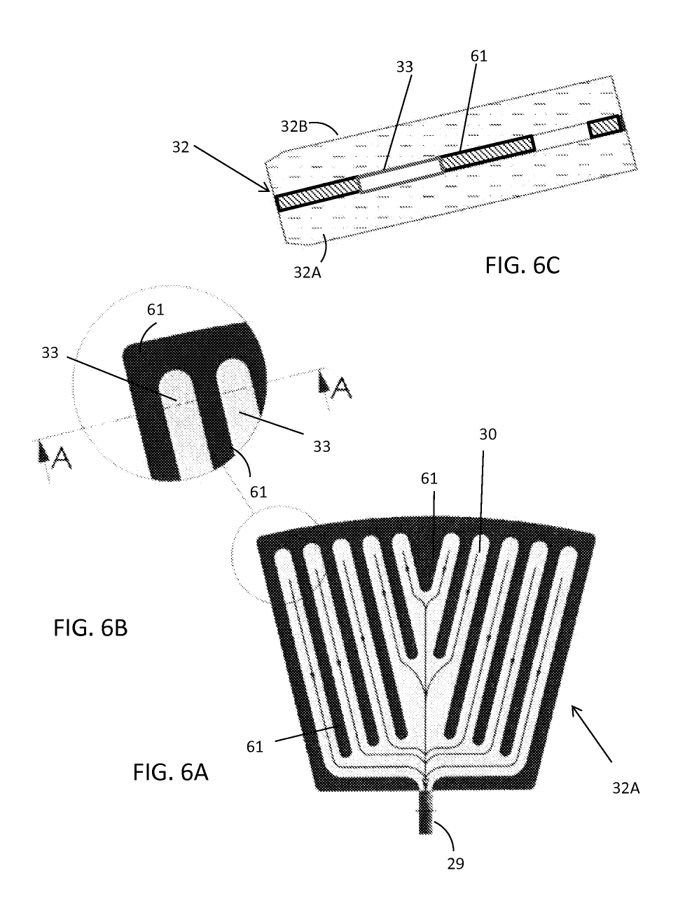

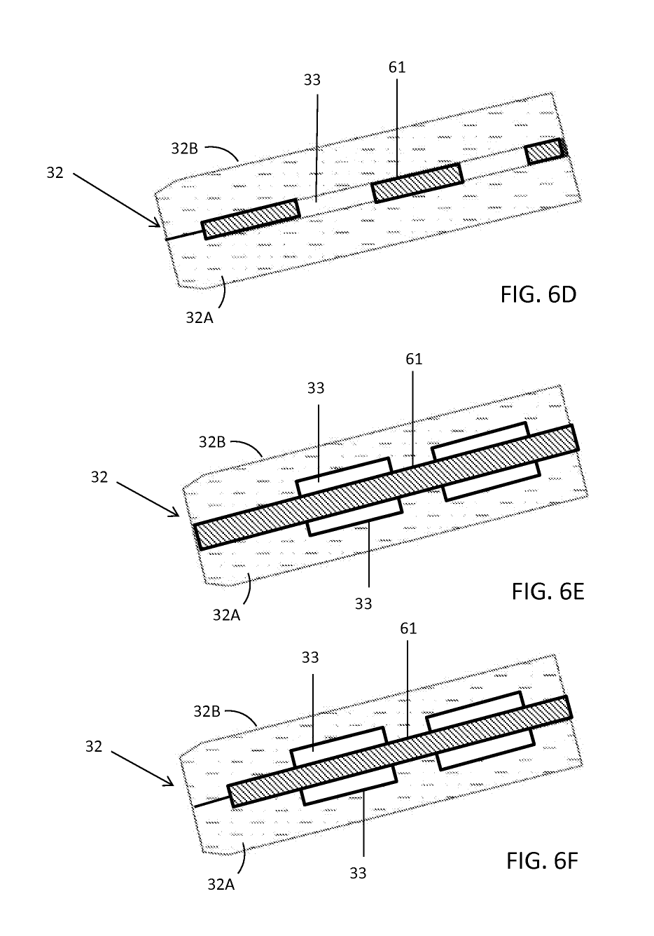

In an embodiment, the magnetic material comprises a thin magnetic sheet 61 provided in the ceramic substrate 32 to form zones which define the filtrate channels 33 between themselves. In an embodiment, the magnetic sheet comprises an opening pattern (channel pattern) that matches to the desired filtrate channels within the ceramic substrate 32 as illustrated in FIGS. 6A, 6B, 6C and 6D. The channel pattern may be made by cutting off the magnetic sheet material in locations of the desired filtrate channels. The thickness or height of the sheet 61 may correspond to that of the filtrate channels 33. In the case of embodiments where the final ceramic substrate 32 is formed of two half-plates 32A and 32B attached together, FIG. 5A may illustrate one of the half-plates 32A, while the other half-plate 32B may be a mirror-image. The substrate 32 may be similar to that illustrated in FIG. 3A that comprises filtrate channels 33 within the ceramic substrate, except that the ceramic substrate zones, such as partition walls 30 which define the filtrated channels 30 between themselves, are replaced by a patterned magnetic sheet. In an exemplary embodiment shown in FIG. 6C, the magnetic sheet extends to the outer edge of the ceramic substrate 32, while in an exemplary embodiment shown in FIG. 6D, the magnetic sheet ends at a location close to the outer edge, the edge being formed by ceramic material in a similar manner as illustrated in FIGS. 3A and 5A.

In an embodiment, each of the half-plates 32A and 32B of the ceramic substrate have filtrate channels 33 on their opposing surfaces, and a magnetic sheet 61 located between the half-plates is uniform and does not contain a cut-off channel pattern, as illustrated in FIGS. 6E and 6F. Thus essentially separate filtrate channels 33 may be formed in the half-plates on both sides of the magnetic sheet 61. In this case the magnet covers 100% of the plate area. In principle the half-plates may be implemented by conventional half-plates having a thin magnetic sheet 61 therebetween. In an embodiment shown in FIG. 6E, the magnetic sheet extends to the outer edge of the ceramic substrate 32, while in an exemplary embodiment shown in FIG. 6F, the magnetic sheet ends at a location close to the outer edge, the edge being formed by ceramic material in a similar manner as illustrated in FIGS. 3A and 5A.

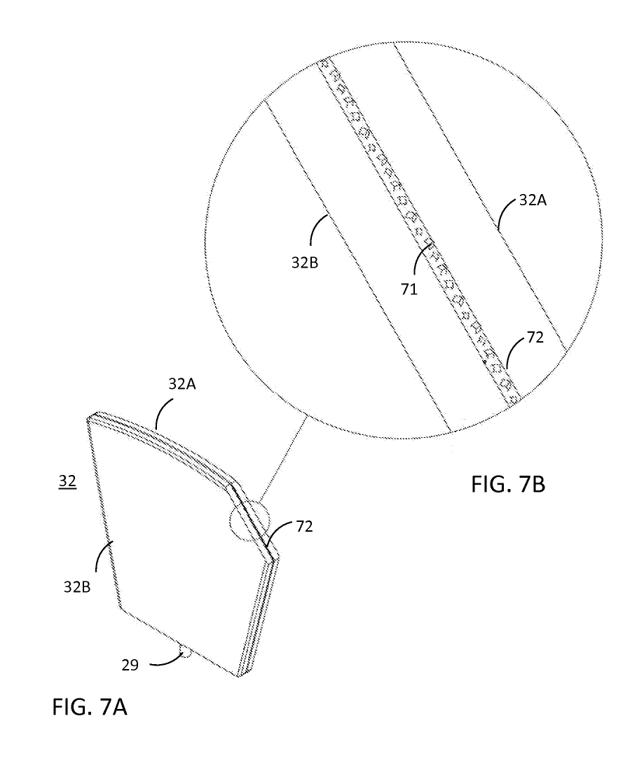

In an embodiment, magnetic material comprises magnetic particles 71 mixed into glue 72 gluing the half-plates 32A and 32B of the ceramic substrate 32 together, as illustrated in FIGS. 7A and 7B. The magnetic particles may be small particles of the size of 100-500 microns (micrometres) in diameter, for example. The magnetic particles 71 may be mixed into the glue 72 prior to gluing the half plates 32A and 32B together. Beyond the glue with magnetic particles, the substrate 32 may be manufactured and may have any structure similar to any ceramic substrate formed of half-plates attached together. The pattern of magnetized zones within a ceramic substrate 32 will correspond to the glued areas, for example the ceramic substrate zones, such as partition walls 30 which define the filtrated channels 30 between themselves as illustrated in FIG. 3A.

In an embodiment, the filter plate may be made of magnetic material. For example, the ceramic substrate may be entirely made of magnetic material, or both the ceramic substrate and the microporous membrane may be entirely made of magnetic material. This means that the ceramic material used contains also magnetic particles.

Although not shown in FIGS. 5A-C, 6A-F, and 7A-7B, in a final filter element 22 both sides of the ceramic substrate 32 is covered by a microporous membrane 31. The membrane 31 may be manufactured in a conventional manner upon having manufactured a ceramic substrate 32 according to embodiments of the invention. The final filter element 22 may have a similar appearance as that shown in FIG. 2, for example. The substrate may also be provided with a tube connector 29 or like.

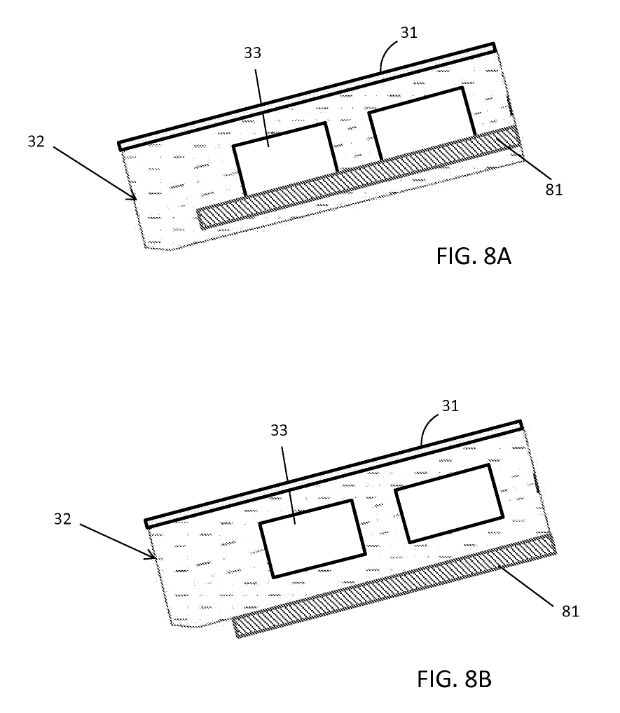

In embodiments, a ceramic microporous layer 31 may cover only one major surface of the ceramic substrate 32 so that the filtering operation is carried out only through that surface, as illustrated in FIGS. 8A and 8B. Therefore, the magnetic material 81, such a thin magnetic sheet can be located within the ceramic substrate behind the filtrate channels 33 and close to the opposite inoperative major surface, as illustrated in FIG. 8A. It is also possible that in the ceramic substrate is made of two half-plates, the bottom half-plate is entirely made of magnetic material. As another example, the magnetic material 81, such as a thin magnetic sheet, can be located behind the ceramic substrate 32 or the filter plate on an opposite major surface. These approaches may be particularly suitable for filter elements of drum filters. In the case of drum filter plates, the surface provided with the microporous membrane 31 may be a curved surface.

The magnetic plate principle was tested with magnetite slurry. It was concluded that the cake thickness was significantly larger when using magnetic field. The test work also surprisingly indicated that a higher hydraulic capacity was obtained with magnetic field, which further enhanced the filtering capacity. It is possible that the magnetic field rearranges the particles in the magnetic field such a way that it has a positive effect on the hydraulic flow. It may also be possible that water molecules are arranged in such a way by the magnetic field that the hydraulic flow is affected. This feature of the magnetic filter plate allows an enhanced filtering effect also in filtering other than magnetite slurry.

An example of a magnetic material suitable for the magnetic elements according to the invention is neodymium-iron-boron (NdFeB) permanent magnet. Size and strength of individual magnets depend on the application and filter element in question. Permanent magnet blocks are commercially available from Webcraft GmbH, Germany, http://www.supermagnete.de, for example. As an alternative to permanent magnets, electromagnets may be used in some applications. For example, in exemplary embodiments shown in FIGS. 8A and 8B the magnetic sheets may be replaced or implemented by electromagnet elements.

Upon reading the present application, it will be obvious to a person skilled in the art that the inventive concept can be implemented in various ways. The invention and its embodiments are not limited to the examples described above but may vary within the scope of the claims.

1. A filter element to be used in removal of liquid from solids containing material in a capillary suction dryer, the filter element comprising:
a ceramic substrate having a first surface and a second opposite surface,
a ceramic microporous layer covering at least one of the first and the second surfaces of the ceramic substrate,
filtrate channels provided within the ceramic porous substrate, whereby a negative pressure can be maintained within the filtrate channels directing liquid from the outer surface of the ceramic microporous layer by capillary action through the microporous layer and further through the ceramic substrate into the filtrate channels and further out of the filter element,
wherein the filter element comprises further magnetic material within the ceramic substrate or on an opposite surface of the ceramic substrate in relation to the microporous layer in the case the microporous layer is positioned on only one of the first and second surfaces of the ceramic substrate.

2. A filter element according to claim 1, wherein the magnetic material is provided in or between the filtrate channels.

3. A filter element according to claim 1, wherein the magnetic material is provided in the ceramic substrate zones which define the filtrated channels between themselves.

4. A filter element according to claim 1, wherein the magnetic material comprises magnetic elements located in cavities provided in the ceramic substrate zones which define the filtrated channels between themselves.

5. A filter element according to claim 1, wherein the ceramic substrate comprises two half-plates glued together, and wherein the magnetic material comprises magnetic particles mixed into glue gluing the half-plates together.

6. A filter element according to claim 1, wherein a core of the ceramic substrate and thereby the filtrate channels is formed by a granular core material, and wherein the granular core material contains magnetic particles or elements.

7. A filter element according to claim 1, wherein the magnetic material comprises magnetic sheet material provided in the ceramic substrate to form zones which define the filtrate channels between themselves.

8. A filter element according to claim 1, wherein the ceramic substrate comprises two half-plates fixed together, and wherein the magnetic material comprises a magnetic sheet provided between the half-plates, the magnetic sheet comprising an opening pattern that matches to the filtrate channels within the ceramic substrate.

9. A filter element according to claim 1, wherein the ceramic substrate comprises two half-plates fixed together, each of the half-plates having filtrate channels on the opposing surfaces, and wherein the magnetic material comprises a magnetic sheet provided between the half-plates.

10. A filter element according to claim 1, wherein the ceramic microporous layer covers only one of the first and the second surfaces of the ceramic substrate, and the magnetic material is provided on the other of the first and the second surfaces of the ceramic substrate.

11. A filter element according to claim 1, wherein the ceramic microporous layer covers only one of the first and the second surfaces of the ceramic substrate and the magnetic material is within the ceramic substrate close to the other of the first and the second surfaces of the ceramic substrate between the filtrate channels and the said other of the first and the second surfaces of the ceramic substrate.

12. A filter element according to claim 1, wherein the ceramic filter element is made of magnetic material.

13. A filter element according to claim 1, wherein the magnetic material comprises permanent magnets or electromagnets.

14. A filter apparatus, comprising one or more filter elements according to claim 1.

15. A method for manufacturing a filter element to be used in removal of liquid from solids containing material in a capillary suction dryer, wherein the method comprises the steps of:
providing a ceramic substrate with filtrate channels within the ceramic substrate, said ceramic substrate having a first surface and a second opposite surface,
coating at least one of the first and the second surface of the ceramic substrate with a ceramic microporous material layer,
whereby a negative pressure can be maintained within the filtrate channels directing liquid from the outer surface of the ceramic microporous layer by capillary action through the microporous layer and further through the ceramic substrate into the filtrate channels and further out of the filter element,
the step of:
providing magnetic material within the ceramic substrate.

16. A method according to claim 15, comprising the step of making the filter element or the ceramic substrate of a magnetic material.
